(19) United States
(12) Patent Application Publication
(10) Pub. No.: US 2016/0300286 A1
(43) Pub. Date: Oct. 13, 2016

(54) METHOD AND APPARATUS FOR PROCESSING AND RELEASING THE INFORMATION OF THE BUSINESS OBJECT

(71) Applicant: Alibaba Group Holding Limited, Grand Cayman (KY)

(72) Inventors: Jinlai YAN, Shanghai (CN); Bin YE, Hangzhou (CN); Weina PU, Hangzhou (CN); Jun ZHANG, Hangzhou (CN)

(21) Appl. No.: 14/923,069

(22) Filed: Oct. 26, 2015

(30) Foreign Application Priority Data
Dec. 26, 2014 (CN) 201410835030.4

(51) Int. Cl. G06Q 30/06; G06F 3/0482; H04L 29/08

(52) U.S. Cl. CPC G06Q 30/0623; H04L 67/104; G06F 3/0482

(57) ABSTRACT

A method and apparatus for processing and releasing the information of a business object. The method includes determining at least one first attribute value in a first hierarchy associated with a target user, determining at least one second attribute value in a second hierarchy associated with the target user. The first hierarchy and the second hierarchy correspond to different category attributes of the business object. Then, determining relationships between the first attribute values of the target user and the second attribute values of the target user. The method further includes preserving the relationships between the first and second attribute values to ascertain a releasing range of the business object in accordance with determined relationships.

### CROSS REFERENCE TO RELATED APPLICATION

This application claims priority to and the benefits of Chinese Patent Application No. 201410835030.4, filed on, Dec. 26, 2014, which is incorporated herein by reference in its entirety.

### TECHNICAL FIELD

The presented disclosure relates generally to the field of information processing and releasing and, more particularly, to methods and apparatuses for processing and releasing business object information.

### BACKGROUND

The consumer-to-consumer (C2C) mode is a typical mode in the E-commerce. In C2C mode, the sellers provide product information; and a standardized management is required to prevent the unexpected deliveries and buying/selling of counterfeit goods.

Typically, in a routing process, the sellers obtain the authorizations before releasing commodities to an e-commerce platform. The authorizations are sorted into two hierarchies: the first type of authorization is selling in the category hierarchy (referred to as “category authorization”) and the second type of authorization is selling in the brand hierarchy (referred to as “brand authorization”). The sellers provide with the authorization a corresponding proof of qualification information, and the sellers can obtain the appropriate authorization based upon a preview by the system audit. Upon the approval of the system audit, the sellers obtain the category authorization; the sellers have the ability to release commodities only in the authorized categories. Upon the approval of the system audit, the sellers obtain the brand authorization; the sellers have the ability to release commodities only in the authorized brands. Thus, the sellers can only release commodities related brands with authorizations in the authorized categories. Typically, when releasing the commodities, the releasing platform demonstrates available categories and brands with the authorizations. Next, when the sellers finish filling out the fields of commodity names, inventory information, etc. A releasing of commodities is considered successfully conducted when the completion of mentioned steps of obtaining the authorizations, filling the required information are done. Then, when done, such releasing process can be enabled and the consumers can proceed with e-commerce operations of searching, browsing and purchasing.

However, there are occurrences that cause a seller to obtain several category authorizations and several brand authorizations simultaneously. For example, assuming a seller obtains two category authorizations in both a mobile phone category and in a women's clothing category at the same time, then obtains two brand authorizations in a brand associated with mobile phones and a brand associated with women's clothing. In the steps of the commodity releasing, the device enables the seller to release commodities associated with the brand of mobile phone under a category of women's clothing, or release commodities brands associated with the brand of women's clothing under a category of mobile phone. Thus, there occurs a misplacement of the to be released commodities when such simultaneous category authorizations and brand authorizations are obtained by the user. This results in irregularities and can affect the searching result of the commodities.

That is, given the fact that the category authorization can lead to a set of misleading results upon the user obtaining multiple authorizations, the present method of processing and releasing such information needs to be improved. Accordingly, it would be desirable to provide techniques to address the shortcomings of present methods.

### SUMMARY OF THE DISCLOSURE

Therefore, it would be advantageous to provide a method and an apparatus for processing and releasing the information of a business object, which avoids the irregularities and presents accurate searching results. Thus, the service efficiency of the network computing resources and the user experience is improved.

Embodiments of the present disclosure provide mechanisms for processing and releasing the information of the business objects according to a relationship between attribute values of a target user where the attribute values are in different hierarchies.

Accordingly, one embodiment of the present disclosure employs a manner of processing information of a business object, which includes determining at least one first attribute value in a first hierarchy associated to the target user, at least one second attribute value in a second hierarchy associated to the target user. The first hierarchy and the second hierarchy correspond to different category attributes of the business object. Then, relationships between the first attribute values and the second attribute values of the target user are ascertained. Further, relationships are preserved to ascertain a releasing range of the business object in accordance with the relationships.

According to another embodiment of the present disclosure for releasing information of a business object, the process includes providing each target user with a releasing range of a business object. The releasing range includes at least one first attribute value in a first hierarchy, at least one second attribute value in a second hierarchy and a relationship between the first and second attribute values. The first attribute values and second attribute values correspond to different category attributes of the business object. Then, the process includes extracting identification information from a client request sent by a client to release information of the business object. Further, the process includes determining the releasing range of the business object in accordance with the extracted identification information from the client request. The releasing range of the business object is forwarded in response to the client request to enable the client to have released the business object by using the forwarded releasing range of the business object.

According to yet another embodiment of the present disclosure for releasing information of a business object, the process includes sending a request to release information of a business object from a client to a server. Then, the process includes receiving releasing range information of the business object returned or forwarded back from the server. Further, the process includes determining a releasing range of the business object using the received releasing range information. The releasing range includes at least one first attribute value in a first hierarchy, at least one second attribute value in a second hierarchy. Sets of relationships between the first attribute value and the second attribute values are created, and included in the releasing range. The first attributes and the second attribute values correspond to different category attributes of the business object.

According to yet another embodiment for releasing information of a business object, the process includes receiving in advance releasing range information of a business object from a server, and preserving the releasing range information locally at a client side. A releasing range includes at least one first attribute value in a first hierarchy, at least one second attribute value in a second hierarchy, and a relationship association between each first attributive value and each second attribute value. The first attribute values and the second attribute values correspond to different category attributes of the business object. Then, the releasing range of the business object is determined, by using the advanced received releasing range information. The releasing range of the business object is made available in an immediate manner upon receiving the request to release a business object at the client side.

According to yet another embodiment for releasing information of a business object, the manner includes providing each target user with a releasing range of a business object. The releasing range includes at least one first attribute value in a first hierarchy, at least one second attribute value in a second hierarchy, and a relationship association between the first and second attribute values. Then, a client receives a request sent from a server to release information of the business object. The request of releasing information of the business object includes a business object to be released, and the selected first and second attribute values of the target user. Further, whether the relationship association between the first and second attribute values falls within the releasing range of the business object is received. The business object is determined in accordance with the selected first attribute values and the selected second attribute values if the relationship association between the first and second attribute values falls within the releasing range received.

According to yet another embodiment for processing information of a business object, the manner includes determining at least one category of a business object in a category hierarchy associated with a target user, and at least one brand of a business object in a brand hierarchy associated with the target user. Then, relationship between each category and each brand of target user are determined. Further, the relationships are preserved to ascertain a releasing range of the business object in accordance with the relationship.

According to yet another embodiment for releasing information of a business object, the manner includes providing each target user with a releasing range of a business object. The releasing range includes at least one category of the business object in a category hierarchy, at least one brand of the business object in a brand hierarchy, and the relationship between the category and brand of the business object. Then, identification information of a requesting user is extracted when the server receives a request to release information of a business object sent from a client side. Further, the manner includes determining the releasing range of the business object in accordance with the identification information of the requesting user. The manner further includes returning or forwarding back the releasing range of the business object to the client in response to the client request to enable the client to release the business object by using the releasing range returned.

According to yet another embodiment for releasing information of a business object, the process includes sending a request to release information of a business object from a client to a server. Then, the process includes receiving releasing range information of the business object returned or forwarded back from the server. Further, the releasing range of the business object is determined in accordance with the received releasing range information. The releasing range includes at least one category of the business object in a category hierarchy, at least one brand of the business object in a brand hierarchy, and a relationship association between each category and each brand of the business object.

According to yet another embodiment for releasing information of a business object, the manner includes pre-receiving or receiving in advance releasing range information of a business object from a server, and preserving the releasing range information locally at a client side. A releasing range includes at least one category of the business object in a category hierarchy, at least one brand of the business object in a brand hierarchy, and a relationship association between each category and each brand of the business object. Then, it is proceeded to release a business object by using the locally preserved releasing range information when the client requests the release of the business object without further releasing range requests to the server.

According to yet another embodiment for releasing information of a business object, the manner includes providing each target user with a releasing range of the business object. The releasing range includes at least one category of the business object in a category hierarchy, at least one brand of the business object in a brand hierarchy, and a relationship association between each category and each brand of the business object. Then, a server receives a request to release information of a business object sent from a client. The request includes a business object to be released, and additionally selected categories and brands of the business object. Further, whether there exists a relationship association between the categories and brands of the business object in the releasing range of the business object is determined. It is then proceeded to release the business object of the selected categories and the selected brands of the business object if a relationship association between the categories and brands of the business object falls within the releasing range of the business object.

According to yet another embodiment of the present disclosure, there is described a device including a unit of a processor to determine at least one first attribute value in a first hierarchy associated with a target user, determining at least one second attribute value in a second hierarchy associate with target user. The first hierarchy and the second hierarchy correspond to different category attributes of the business object. Another unit of the processor is included in the device to determine a relationship between the first and second attribute values. And, a storage unit is included to preserve the relationship and ascertain a releasing range of the business object in accordance with the relationship.

According to yet another embodiment of the present disclosure for releasing information of a business object, a device is applicable to a server. A server provides each target user with a releasing range of a business object. The releasing range includes at least one first attribute value in a first hierarchy, at least one second attribute value in a second hierarchy, and the relationship between each first attribute value and each second attribute value. The first attribute values and the second attribute values correspond to different category attributes of the business object. The device includes a unit of a processor to extract identification information of a requesting user if the server receives a request to release information of the business object via the request sent from a client side. The device also includes another unit of the processor to determine the releasing range of the business object in accordance with the identification information of the requesting user. The device includes yet another unit of the processor to return the releasing range of the business object to the client in response to the client request to enable the client to release the business object by using the releasing range returned.

According to yet another embodiment of the present disclosure for releasing information of a business object, a device is applicable to a client. The device includes a unit of a processor to send a server a request to release information of a business object. The device also includes another unit of the processor to receive releasing range information of the business object returned from the server. The device includes yet another unit of the processor to determine the releasing range of the business object in accordance with the received releasing range information. The releasing range includes at least one first attribute value in a first hierarchy, at least one second attribute value in a second hierarchy, and a relationship association between the first and second attribute values. The first attribute values and the second attribute values correspond to different category attributes of the business object.

According to yet another embodiment of the present disclosure for releasing information of a business object, a device is applicable to a client. The device includes a unit of a processor to pre-receive or receiving in advance releasing range information of a business object from a server, and preserving the releasing range information locally at a client side. The releasing range includes at least one first attribute value in a first hierarchy, at least one second attribute value in a second hierarchy, and a relationship association between the first and second attribute values. The first attribute values and the second attribute values correspond to different category attributes of the business object. The device includes yet another unit of the processor to proceed to release the business object by using the locally preserved releasing range information when the client requests the release of the business object without further releasing range requests to the server.

According to yet another embodiment of the present disclosure for releasing information of a business object, a device is applicable to a server. A server provides each target user with a releasing range of a business object. The releasing range includes at least one first attribute value in a first hierarchy, at least one second attribute value in a second hierarchy, and a relationship association between the first attribute values and the second attribute values. The device includes a unit of a processor to receive a request to release information of a business object sent from the client. The request includes the business object to be released, and additionally selected first and second attribute values of the target user. The device also includes yet another unit of the processor to determine whether a relationship association between the first attribute values and the second attribute values falls within a releasing range of the business object. The device includes still yet another unit of the processor to release the business object in accordance with the selected first attribute values and the selected second attribute values if the relationship association between the first attribute values and the second attribute values falls within the releasing range of the business object.

According to another embodiment of the present disclosure for releasing information of the business object, a device includes a unit of a processor to determine at least one category of business object in a category hierarchy associated with a target user, and at least one brand of the business object in a brand hierarchy associated with the target user. The device also includes another unit of the processor to determine the relationship between each category and each brand of the target user. The device includes a storage unit to store the relationship to ascertain the releasing range of the business object in accordance with the relationship.

According to yet another embodiment of the present disclosure for releasing information of a business object, a device is applicable to a server. A server provides each target user with a releasing range of the business object. The releasing range includes at least one category of the business object in a category hierarchy, at least one brand of the business object in a brand hierarchy, and a relationship association between the category and brand of the business object. The device includes a unit of a processor to extract identification information of a requesting user if the server receives a request to release information of the business object via the request sent from a client side. The device also includes another unit of the processor to determine the releasing range of the business object in accordance with the identification information of the requesting user. The device includes yet another unit of the processor to return the releasing range of the business object in response to the client request in order to enable the client to release the business object by using the received releasing range of the business object.

According to yet another embodiment of the present disclosure for releasing information of a business object, a device is applicable to a client. The device includes a unit of a processor to send a request to release information of a business object to a server. The device also includes another unit of the processor to receive releasing range information of the business object returned from server. The device includes yet another unit of the processor to determine a releasing range of the business object in accordance with the received releasing range information. The releasing range includes at least one category of the business object in a category hierarchy, at least one brand of the business object in a brand hierarchy, and a relationship association between each category and each brand of the business object.

According to yet another embodiment of the present disclosure for releasing information of a business object, a device is applicable to a client. The device includes a unit of a processor to receive in advance releasing range information of a business object from a server, and preserving the releasing range information locally at the client side. A releasing range includes at least one category of the business object in a category hierarchy, at least one brand of the business object in a brand hierarchy, and a relationship association between each category and each brand of the business object. The device also includes another unit of the processor to proceed to release the business object by using the locally preserved releasing range information when the client requests the release of the business object without further releasing range requests to the server.

According to yet another embodiment of the present disclosure for releasing information of a business object, a device is applicable to a server. A server provides each target user with a releasing range of the business object. The releasing range includes at least one category of the business object in a category hierarchy, at least one brand of the business object in a brand hierarchy, and a relationship association between each category and each brand of the business object. The device includes a unit of a processor for the server to receive the request to release the information of the business object sent from the client. The request includes the business object to be released, and additionally selected categories and brands of the business object. The device also includes another unit of the processor to determine whether the relationship association between the categories of the business object and brands of the business object falls within the releasing range of the business object. The device includes yet another unit of the processor to proceed to release the business object in accordance with the selected categories of the business object and brands of the business object if a relationship association between the categories of the business object and brands of the business object falls within the releasing range received.

This summary includes, by necessity, simplification, generalizations and omissions of detail; consequently, those skilled in the art will appreciated that the summary is illustrative only and is not intended to be in any way limiting. Other aspects, inventive features, and advantages of the present disclosures, as defined solely by the claims, will become apparent in the non-limiting detailed description set forth below.

### DESCRIPTION OF THE DRAWINGS

Embodiments of the disclosure will be better understood from a reading of the following detailed description, taken in conjunction with the accompanying drawing in which like reference characters designate like elements.

FIG. 1 is a flow diagram of a first method provided by an embodiment.

FIG. 2 is a schematic diagram of simplified storage structure of a method provided by an embodiment.

FIG. 3 is a flow diagram of a second method provided by an embodiment.

FIG. 4 is a schematic diagram of information releasing interface of a method provided by an embodiment.

FIG. 5 is a flow diagram of a third method provided by an embodiment.

FIG. 6 is a flow diagram of a forth method provided by an embodiment.

FIG. 7 is a flow diagram of a fifth method provided by an embodiment.

FIG. 8 is a flow diagram of a sixth method provided by an embodiment.

FIG. 9 is a block diagram of a first apparatus provided by an embodiment.

FIG. 10 is a block diagram of a second apparatus provided by an embodiment.

FIG. 11 is a block diagram of a third apparatus provided by an embodiment.

FIG. 12 is a block diagram of a forth apparatus provided by an embodiment.

FIG. 13 is a block diagram of a fifth apparatus provided by an embodiment.

FIG. 14 is a block diagram of a sixth apparatus provided by an embodiment.

FIG. 15 is a block diagram of part of a method and an apparatus for processing and releasing information of a business object provided by an embodiment.

### DETAILED DESCRIPTION

Reference will now be made in detail to embodiments, examples of which are illustrated in the accompanying drawings. While the disclosure will be described in conjunction with the embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of embodiments, numerous specific details are set forth in order to provide a thorough understanding of the disclosure. However, it will be recognized by one of ordinary skill in the art that embodiments may be practiced without these specific details. In other examples, well-known methods, procedures, and components have not been described in detail so as not to unnecessarily obscure aspects of an embodiments. The drawings showing embodiments are not to scale and, particularly, some of hierarchies are for the clarity of presentation and are shown exaggerated in the drawings. Similarly, although the views in the drawings for the ease of description generally show similar orientations, this depiction in the drawings is arbitrary for the most part. Generally, the disclosure is not limited to an orientation.

It should be noticed that when determining a releasing range of a business object, it is not necessary that hierarchies associated with a target user be a category hierarchy and a brand hierarchy. There are other possibilities. Unless specifically stated otherwise, the hierarchies in the embodiments are a first hierarchy and a second hierarchy. When a user obtains the authorizations, it is considered as the authorization of at least one first attribute value (for example, mobile phones, women's clothing, electric appliances, men's clothing, jewelries, sports, infants & mothers, children's clothing, food, household appliances, digital products, furniture, automotive, etc.) in the first hierarchy (for example, the categories of commodities), and the authorization of at least a second attribute value (for example, “Apple” in mobile phones, “Brand A” in women's clothing, “Hong Qi” in automotive, etc.) in the second hierarchy (for example, brands of the commodities). In the present embodiments, the first attribute values and the second attribute values with the authorizations are referred to as the first attribute values and the second attribute values associated with the target user. Such correlations can also be reflected in other areas, but are not to be limited to the releasing authorizations the users obtained.

Each first attribute value and each second attribute value corresponds to a specific category of a business object. A user can release specific information of the business object under the category corresponding to an attribute value, if the business object is associated with an attribute value. Moreover, the first hierarchy and the second hierarchy correspond to different category attributes of the business object. There is no inclusion relation, affiliation, superordinate or subordinate relationship, etc. between the two hierarchies. For example, the category hierarchy and the brand hierarchy are both independent, they are classified in accordance with respective systems, and they will not interfere with each other.

The generation of the relationship between a first attribute value and a second attribute value can regulate the releasing of the information. In this way, when a user is to release information of a business object, the options of the second attribute values are limited only to the second attribute values, which relate to the first attribute value upon the selection of the first attribute value. Moreover, if the user obtains the authorization of a second attribute value, but the second attribute value does not have any relation with the selected first attribute value, the second attribute value will not be selected.

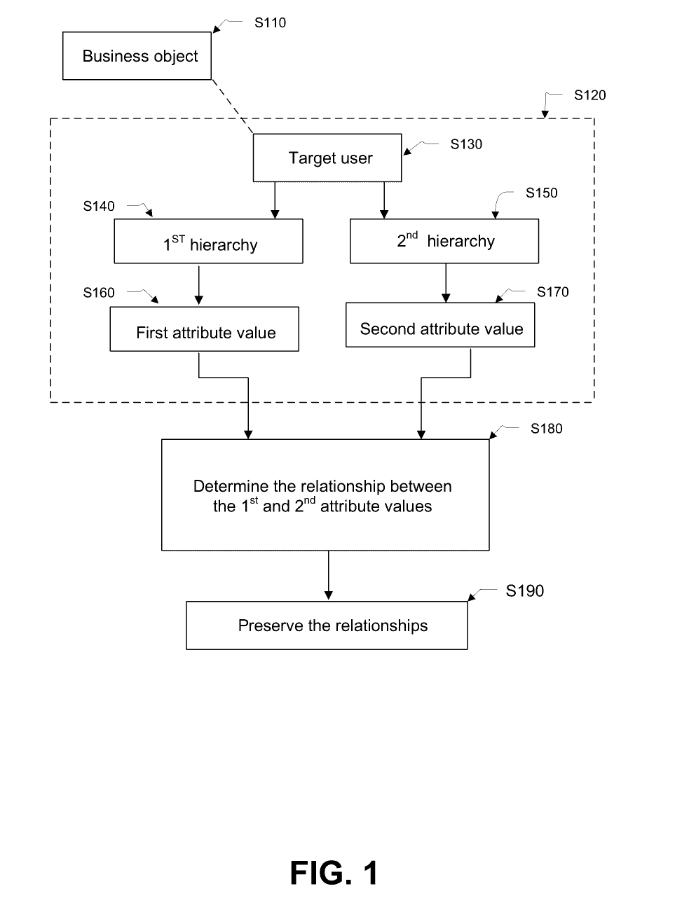

FIG. 1 shows the step of applying for a first and a second attribute values. In step S120, at least one first attribute value S160 in the first hierarchy S140 associated with a target user S130 and at least one second attribute value S170 in the second hierarchy S150 associated with a target user S130 are determined. The first attribute values and the second attribute values correspond to different category attributes of the business object S110.

In step S120, a user can select the first attribute values S160 in the first hierarchy S140 and submit the qualification information, known as the proof to prove an attribute value is in a hierarchy, to the system for audit. The system will grant authorizations to release information of a business object under the first attribute values S160 to the user upon approval. Next, the user applies for the second attribute values S170 in the second hierarchy S150 and submits the qualification information to the system for audit. The system will grant the authorizations to release the information of the business object under the second attribute values S170 to the user upon approval.

In step S180, a relationship between each first attribute value S160 and each second attribute value S170 associated with the target user S130 is determined. As an example, knowing a user is associated with a set of first attribute values such as A1 and A2 and a set of the second attribute values such as B1, B2, B4 and B5, from which, the next step is to determine which second attribute values correspond to the first attribute values A1 and A2. There are several ways to determine the correspondence between the second attribute values and the first attribute values.

One way is to predetermine a set of the first attribute values in the first hierarchy (for example, all the categories defined in the platform can be included under the category hierarchy), and a set of the second attribute values in the second hierarchy (for example, all the acknowledged brands can be included under the brand hierarchy), and then generate a table of the relationships between the first attribute values S160 and the second attribute values S170 in accordance with the set of the first attribute values and the set of the second attribute values. Table 1 shows an example of the generated table:

TABLE 1

| The first attribute values | The second attribute values |
|---|---|
| A1 | B1, B2. B3 . . . |
| A2 | B4, B5, B6 . . . |
| . . . | . . . |

It is possible that several second attribute values correspond to a first attribute value and a second attribute value corresponds to multiple first attribute values. The table can be generated based on experience. When a user obtains the authorizations, it can be determined by querying the table which second attribute values correspond to each first attribute value. In the example, it can be determined that A1 corresponds to B1 and B2, and A2 corresponds to B4 and B5.

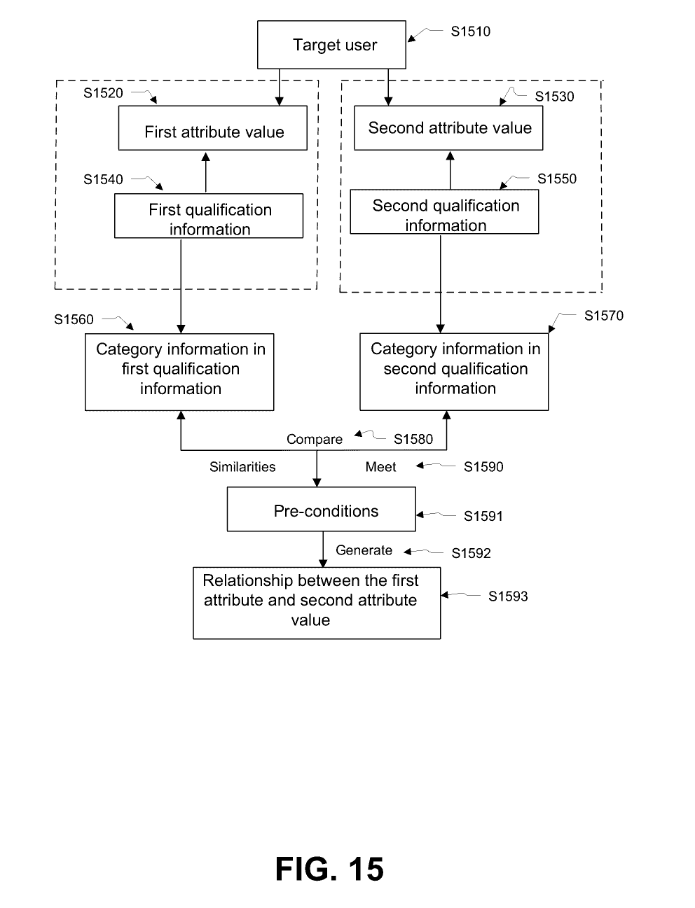

In another way, users normally provide some qualification information when applying for an attribute value. For example, the required qualification information can be the business license issued by the Industrial and Commercial Bureau, etc. Different attribute values require different qualification information, but the category information of the business object is normally included, such as clothing and accessories. If there are remarkable similarities between the category information of the business object in the qualification information of the first attribute values and the category information of the business object in the qualification information of the second attribute values, the relationships between the first attribute values and the second attribute values can be confirmed. FIG. 15 shows another way to determine a relationship between the first and second attribute values. In step S1580, the category information S1560 of a business object in the first qualification information S1540 of a first attribute value S1520 and the category information S1570 of the business object in the second qualification information S1550 of a second attribute value S1530 is compared. In step S1590, if the similarities meet the pre-conditions S1591, the relationship between the first and second attribute values S1593 is generated in S1592.

It should be noted that the qualification information the users provided can be in the format of drawings, when the application program is to determine the relationship in accordance with these drawings, the recognition technology can be adopted to recognize the text in the drawings and then compare the information based on the text.

The first hierarchy can be the category hierarchy, but the category can be different from the authorized category included in the qualification information. The specific categories such as the first category and the second category under the category hierarchy are defined by the e-commerce platform. The functions are to facilitate the management and searching of the business objects. While the category information of the business object in the qualification information is defined by the Industrial and Commercial Bureau according to the “Table of commodity categories,” or defined by the authorized category of the business object upon the registration of the trademark.

Another way is to combine the previous two embodiments, generating a table of the relationship between each first attribute value and each second attribute value. The first attribute values are defined by the platform and the users cannot add new first attribute values. The first attribute values included in the table is generally comprehensive. The second attribute values can be defined by the producer of the business objects, which indicates that the second attribute values preserved in the table are not comprehensive. There can be new second attribute values. For example, when the first hierarchy is the category hierarchy, each first attribute value is predetermined by the platform, such as women's clothing and men's clothing, etc. And there are normally multi-stage categories under the category hierarchy such as, the category of women's clothing includes several subcategories: skirts, shirts and trench coats, etc.; each subcategory includes further subcategories. Users can select one category and one or several subcategories under the category when selecting the first attribute values. When the brand hierarchy is the second hierarchy, each second attribute value under the brand hierarchy can be pre-collected by the platform, for example, some common brands of women's clothing and mobile phones, etc. It can also be some new on-line brands or original designers' brands. It is possible that the second attribute value does not exist in the table upon the determination of the second attribute values associated with the target user.

Then, the second qualification information provided by the target user for the second attribute value, and the first qualification information provided by the target user for the first attribute value is to be determined first. Next, each component of the category information of the business object in the first qualification information and each component of the category information of the business object in the second qualification information is compared. At last, the relationship between the first attribute value and the second attribute value is generated if the similarities between the category information of the business object in the first qualification information and the category information of the business object in the second qualification information meet the preconditions. Moreover, the table can be updated by adding the relationship between the first attribute value and the second attribute value.

In S190 the relationships are preserved to determine the releasing range of the business object in accordance with the relationships. For example, in step S180, the releasing range of the business object can be stored as table 2:

TABLE 2

| | | Associated second attribute |
|---|---|---|
| User's identification | First attribute value | value |
| User A | A1 | B1, B2 |
| | A2 | B4, B5 |

As shown in Table 2, user A can control the releasing. The releasing range includes all the selected attribute values. The user can select one first attribute value and then select the second attribute values. The releasing range can be “the first attribute value A1-the second attribute value B2”. The purpose of utilizing the relationship is to avoid the situations such as, the information is released to the range “the first attribute value A1-the second attribute value B4” and “the first attribute value A2-the second attribute value B1”, where the relationship between A1 and B4, B5; and relationship between A2 and B1, B2 do not exist.

There are multiple means to control the releasing range of the business object. For example, according to Table 2, each first attribute value associate to User A will be demonstrated to User A, upon the selection of one of the first attribute values, such as A1, the second attribute values in associate with both User A and the first attribute value A1 will be picked out and demonstrated to User A, which are B1 and B2. Thus, User A can only choose between B1 and B2, but not between B4 and B5, because there are no relationships between B4, B5 and A1. Upon the selection of A1, User A can no longer choose from B4 and B5. The unexpected deliveries can be prevented in this way.

If the first hierarchy is the category hierarchy, each first attribute value is a category. The structure of the category is typically a tree structure including the first category, the second category and the third category. There is a parent-child relation between each category level. In an embodiment, each first attribute value associated with the target user can be specified as the subcategory under the parent category. For example, when applying for the corresponding categories, the user can obtain the category specified to the subcategory. Since there are multiple second categories under the same category, and multiple third categories under the same first and second category, there are numerous possibilities for the first attribute values associated with the target user. There can be a large amount of information if all the association relationships between the first attribute values and the second attribute values are preserved. Especially when there are large amounts of users, large storage space is required. The present embodiments determine whether the target user is associated to nearly all the subcategories under a parent category, and whether each subcategory is corresponding to the same second attribute value (a certain brand, for example). If the target user is associated to nearly all the subcategories under a parent category, and each subcategory corresponds to the same second attribute value, the relationship between each subcategory and the corresponding second attribute value can be merged together into the relationship between the parent category and the corresponding second attribute value and preserved. If the target user is not associated to all the subcategories under a parent category, and not all the subcategories correspond to the same second attribute value, preserve respectively the relationships between the authorized subcategories and the corresponding second attribute values. The storage structure can be simplified, and the amount of the information needs to be preserved can be reduced in this way.

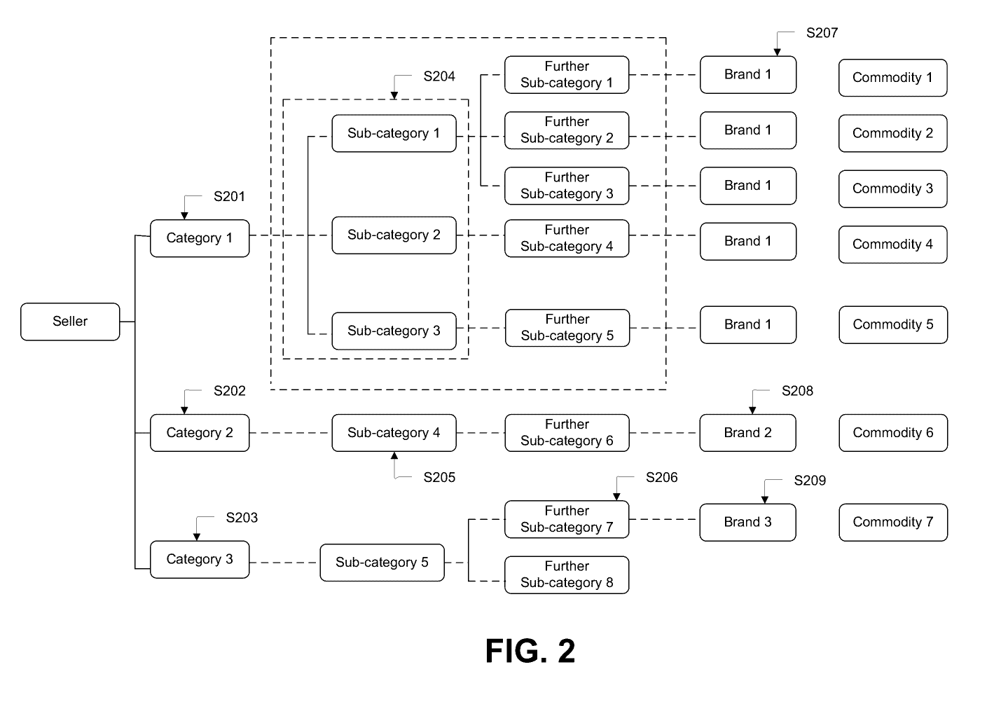

FIG. 2 shows an example that a user is associated with category 1 S201 and all its subcategories S204, category 2 S202 and all its subcategories S205, but the user is associated with only further subcategory 7 S206 under category 3 S203. Category 1 and all its subcategories are associated with brand 1 S207 (assuming the second hierarchy is brand), and category 2 and all its subcategories are associated with brand 2 S208, and only further subcategory 7 under category 3 is associated with brand 3 S209. Then it is sufficient to preserve the relationship between category 1 and brand 1, the relationship between category 2 and brand 2, and the relationship between further subcategory 7 and brand 3. That is, the content in the dash box in FIG. 2 can be combined. Thus, the user can regulate the releasing of all the commodities in brand 1 under all the categories under category 1, all the commodities in brand 2 under all the categories under category 2, and only the commodities in brand 3 under further sub-category 7 under category 3.

It should be noted that, in an embodiment, the operator of the steps is the server of the platform. Normally, when users apply for attribute values associated with the users, requests are sent to the server, and the server determines to grant authorizations with attribute values to the users, and records the authorizations. The server stores all the information including the selected attribute values associated with the user and the relationships between the first attribute values and the second attribute values. The user can use the preserved information to control the releasing range when releasing the information of the business object. The first attribute values and the second attribute values are different for different users, and the information determined for the user is only valid to that user. After the server determines the releasing range of the business object, the server can push the information to the user terminals. The releasing range includes the first attribute values, the second attribute values, and the relationships between the first attribute values and the second attribute values. The client preserves the information locally at a client side. The users can control the releasing range of the business object in accordance with the information preserved at the client side when releasing information of the business object afterwards.

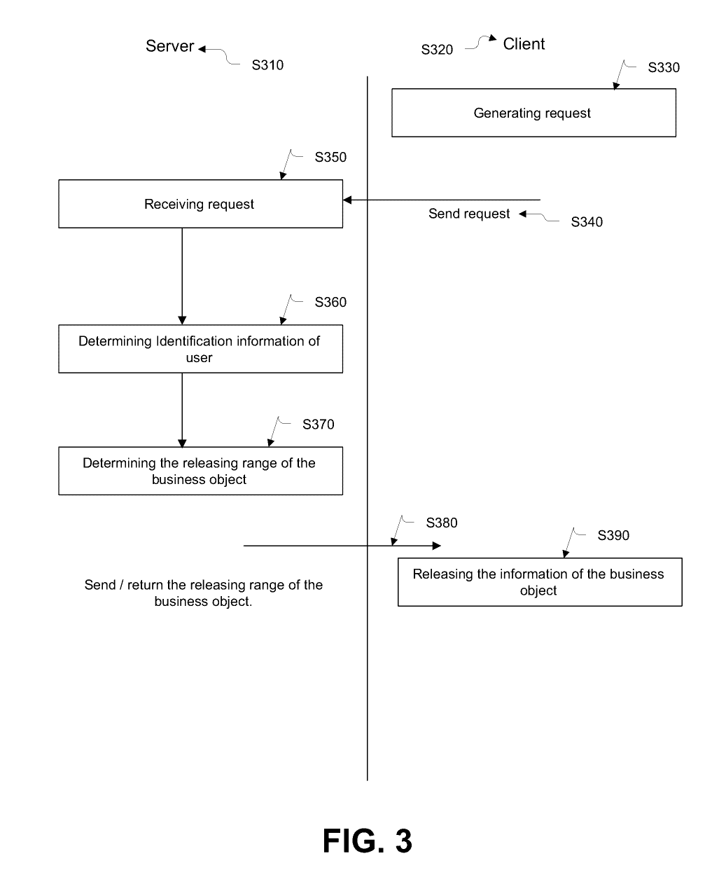

In an embodiment, the server determines a releasing range of a business object and preserves information at a client terminal. The releasing range of the business object including first attribute values, second attribute values and a relationship association between the first attribute values and the second attribute values. FIG. 3 shows the steps of the whole process from the perspective of the server. In step S330, the client S320 generates the request to release the information of the business object and in S340 the client S320 sends the request to the server S310. In S350, the server S310 receives the request to release the information of the business object. In S360, the server S310 determines the identification information of the requesting user after receiving the request to release the information of the business object. The user logs in with the identification information registered with the server, requests to release the information. The request includes the identification information of the requesting user. The server can extract the identification information of the requesting user.

In step S370, the server S310 determines a releasing range of a selected business object according to the identification information of the user in step S360. After the server determines the identification information of the user, the server can determine the releasing range of the business object in accordance with the identification information.

In step S380, the server S310 returns the releasing range of the business object to the client S320 to let the client utilize the obtained information to release the business object in step S390. The server can return the information of the releasing range to the client after the server determines the releasing range of the business object. There are multiple ways to return the releasing range of the business object. For example, the server can return all the information of the business object associated with the user including at least one authorized first attribute value in the first hierarchy, at least one authorized second attribute value in the second hierarchy and the relationship between each first attribute value and each second attribute value. The client can control the releasing range in accordance with the received information. An example of controlling the releasing range is after the selection the first attribute value in the first hierarchy, the client can issue the authorization to the user for the second hierarchy, and determines the second attribute value associated with the first attribute value, and then provides options for the second attribute value in accordance with the second attribute value.

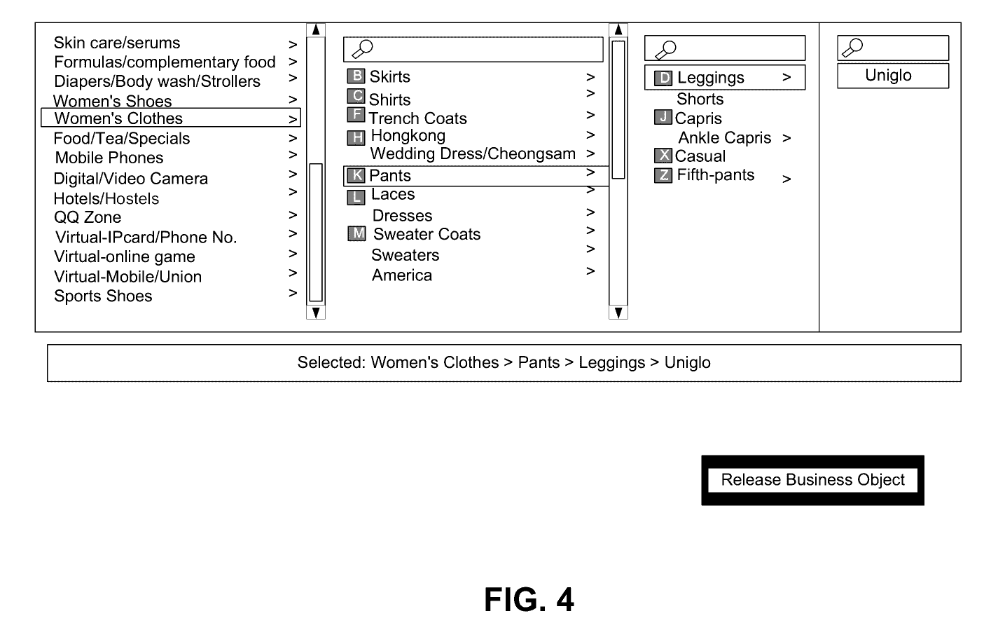

FIG. 4 shows that a user obtains authorizations of the first categories including skincare/body care/serums, formula/food supplement/nutrition, diapers/baby care/feeding/strollers, women's shoes, women's clothing, mobile phones, etc. When the user is to release the information of the business object, all the first categories can be demonstrated to the user. Assuming the target user selects women's clothing, all the authorized second categories under the first categories can be determined, such as, skirts, shirts, trench coats, Hong Kong, wedding dresses/cheongsam/dress, pants, etc. Assuming the user selects pants in the second category; the authorized third category under the second category can be determined, such as leggings, shorts, etc. Assuming the user selects leggings in the third category, and the third category has a further subcategory, the user then finishes the selection about the category hierarchy. Then the authorized brands associated with the further subcategory can be determined, assuming the authorized brand is Brand A. Brand A will be provided to the target user for selection. The user can also obtain authorizations of other brands, such as Apple, but since the selected “women's clothing-pants-legging” is not associated with “Apple”, the user can no longer select it. If the user needs to release the information of other brands of the business objects, the user has to reselect the categories associated with other brands.

It should be noticed that, when the first hierarchy is the category hierarchy, the storage structure can be simplified when preserving all the relationships between the first attribute values and the second attribute values. When a user is related to nearly all the subcategories under a parent category, and all the subcategories are relate to the same second attribute value, the relationship between each subcategory and the second attribute value can be merged together into the relationship between the parent category and the second attribute value and preserved. When controlling the releasing range utilizing the preserved relationship, it is possible that the relationship between the further subcategory and the second attribute value does not exist in the preserved releasing range. The server can check the selected path to locate the parent category of the further subcategory, or to check whether there is a second attribute value associated with the parent category of the parent category, if there is a second attribute value associated with the parent category of the parent category, it can be determined that the second attribute value is associated with the further subcategory and the further subcategory can be demonstrated to the user for selection.

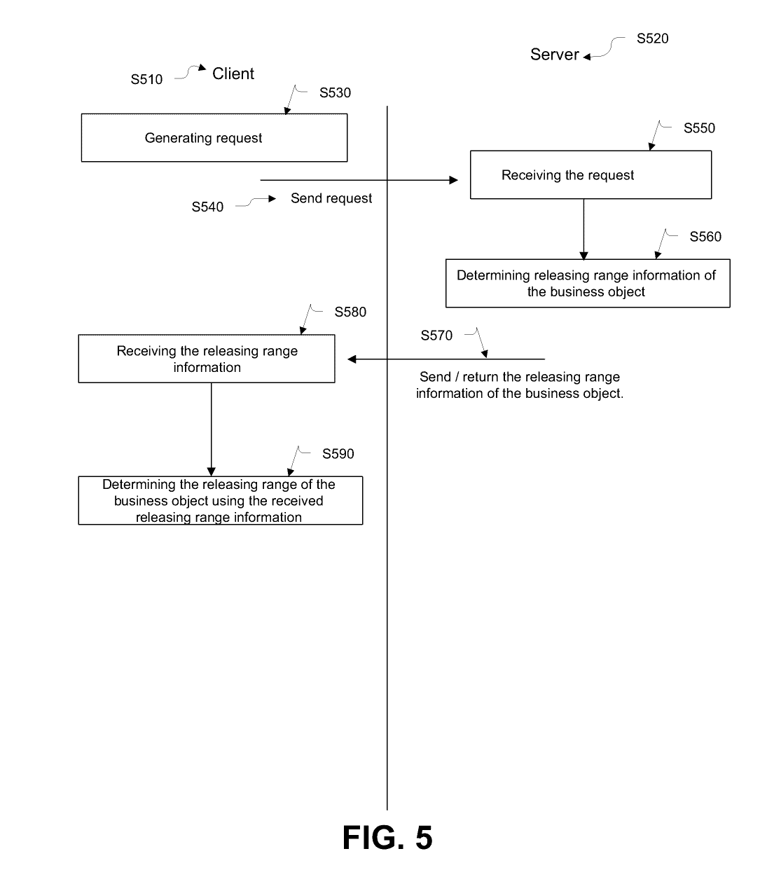

FIG. 5 shows the steps to release information of a business object from the perspective of the client. In step S530, the client S510 generates the request to release the information of the business object and in S540 the client S510 sends the request to server S520. In S550, the server S520 receives the request and in S560 the server determines the releasing range information of the business object. In step S570, the server returns the releasing range information of the business object to the client. In step 580, the client receives the releasing range information returned in step S570, and the client determines the releasing range of the business object using the received releasing range information of the business object. The releasing range includes at least one first attribute value in the first hierarchy, at least one second attribute value in the second hierarchy, and a relationship association between each first attributive value and each second attribute value. The first attribute values and the second attribute values correspond to different category attributes of the business object.

When controlling a releasing range of a business object, the options for the first attribute value are provided in accordance with at least one authorized first attribute value in the first hierarchy. An authorized first attribute value is included in the information returned from the server. Upon the selection of the first attribute values, the second attribute values can be determined. The second attribute values are in association with both the target user in the second hierarchy and with the first hierarchy of the target user. Based on the second attribute values of the target user, the options for the second attribute value can be provided.

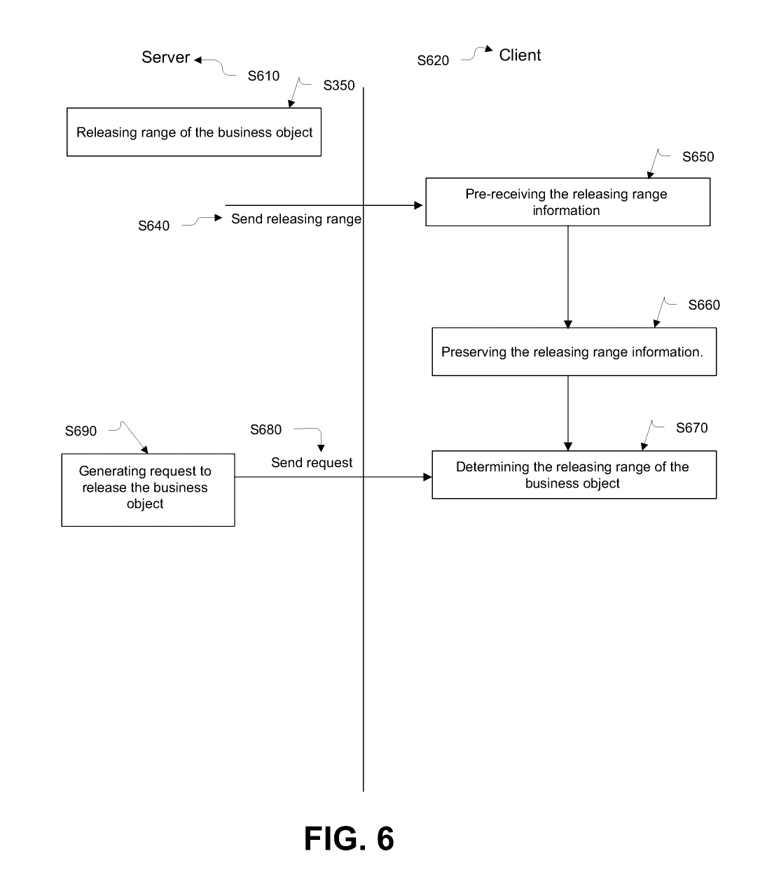

FIG. 6 shows the steps for releasing information of a business object from the perspective of the client. In step S650, the client S620 pre-receives releasing range information of the business object S630 sent from the server S610. In step S660, the client preserves the releasing range information locally at the client side/user terminal. The client pre-receives the releasing range information of the business object from the server S610, and preserves the releasing range information locally at the client side. A releasing range includes at least one first attribute value in a first hierarchy, at least one second attribute value in a second hierarchy, and a relationship association between each first attributive value and each second attribute value.

The client S620 controls the releasing range of the business object in accordance with the releasing range information preserved locally at the client side/user terminal when receiving the request to release the business object. When the server S610 generates the request to release the business object in S690, and sends the request to the client S620 in S680, in step S690 the client determines the releasing range of the business object. When controlling the releasing range of the business object information, the options for the first attribute value can be provided in accordance with the at least one authorized first attribute value in a first hierarchy. The authorized first attribute values are included in the releasing range information returned from the server. Upon the selection of the first attribute values, the second attribute values can be determined. The second attribute values are with the authorization in a second hierarchy and are in association with the first attribute value of the target user. The options for the second attribute value are provided based on the second attribute values of the target user.

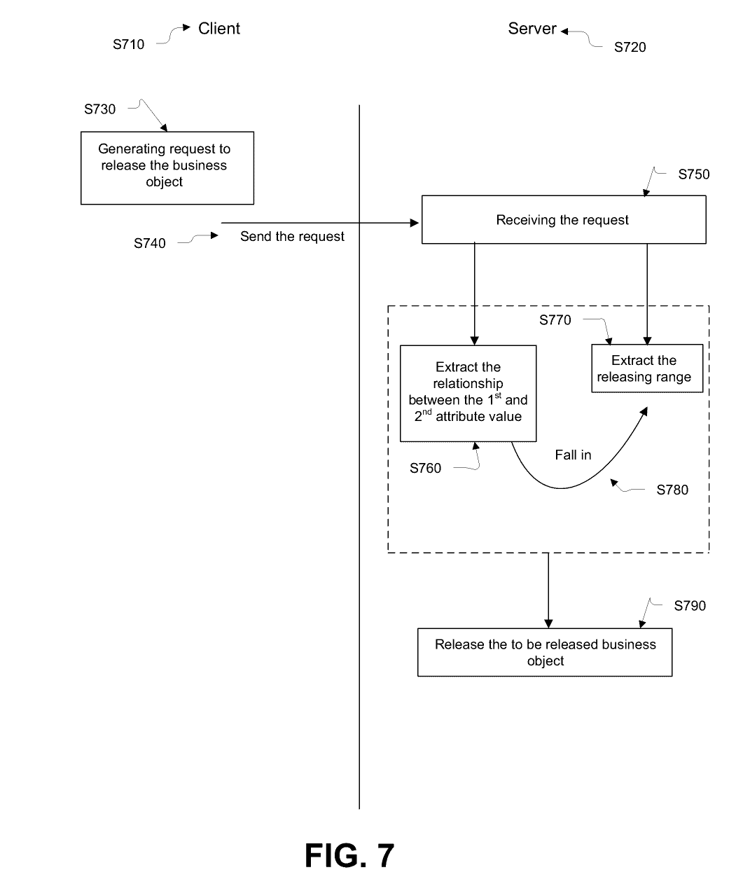

FIG. 7 shows the steps for releasing information of a business object. The server provides each target user with a releasing range of a business object. The releasing range includes at least one first attribute value in a first hierarchy, at least one second attribute value in a second hierarchy, and a relationship association between each first attribute value and each second attribute value. In step S730, the client S710 generates a request to release information of a business object, and sends the request in S740 to the server S720. In step S750, the server receives the request of releasing the information of the business object. The request includes the to be released information of the business object, and additionally selected first attribute values and the selected second attribute values of the target user.

The user selects the releasing range, the first attribute values and the second attribute values of the target before the client sends the request to the server to release the information of the business object. For example, the first attribute value selected is women's clothing, and the second attribute value selected is brand A.

The server then extracts the relationship between the first and second attribute value in S760, and extracts the releasing range of the business object in S770. Then, in S780 the server determines if the relationship between first and second attribute value falls within the releasing range of the business object. After determining the releasing information of the business object, the server identifies whether the selected first attribute values and the selected second attribute values of the target the user are included in the releasing range of the business object. If the selected first attribute values and the selected second attribute values of the target the user are included in the releasing range of the business object, the server identifies whether the relationships between the selected first attribute values and the selected second attribute values are included in the releasing range of the business object.

In S790, the server releases the to be released business object if the relationship association between first and second attribute value falls within the releasing range of the business object. The server releases the information of the business object as the selected range including the first and the second attribute values. If the relationship association between the first attribute value and the second attribute value does not fall within the releasing range of the business object, the system will show an error or warning to let the user modify the releasing range.

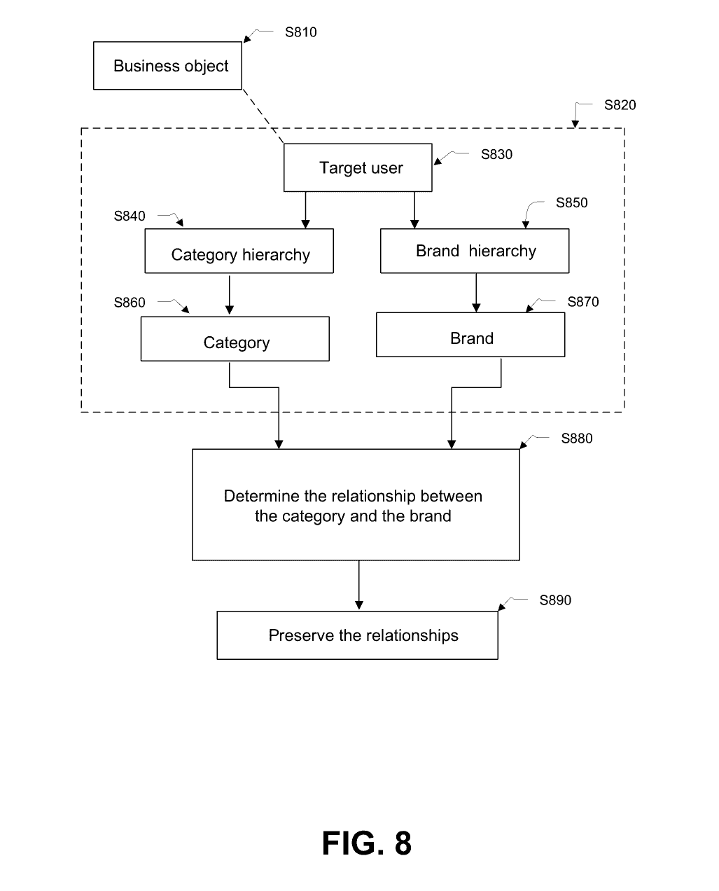

The first hierarchy can be the category hierarchy, where each first attribute value is a specific category (including women's clothing, men's clothing and digital products, etc.), and the second hierarchy is the brand hierarchy where each second attribute value is a specific brand (including brand A, Apple, etc.). FIG. 8 shows the steps for releasing the information of the business object. In step S820, it is determined that at least one category S860 in the category hierarchy S840 and at least one brand S870 in the brand hierarchy S850 are associated with the target user S830

In step S880, the relationship between the category and the brand is determined.

In step S890, the relationship between the category and the brand is preserved. The relationship will be used to determine the releasing range of the target. There is occurrence that the category hierarchy includes a multi-stage category. When preserving the relationships, it can be identified whether the target user is associated with nearly all the subcategories under the parent category and whether each subcategory is associated with the brand of the business object. If the target user is associated with nearly all the subcategories under the parent category and each subcategory is associated with the brand of the business object, merge together the relationship between each subcategory and the corresponding brand of the business object into the relationship between the category and the corresponding brand of the business object. Thus, the storage structure can be simplified. If the target user is not associated with all the subcategories under the parent category and not all the subcategories are associated with the same brand of the business object, each relationship between the subcategory and the corresponding brand of the business object is preserved separately.

The server provides each target user with a releasing range of a business object. The releasing range includes at least one category of the business object in the category hierarchy, at least one brand of the business object in the brand hierarchy, and the relationship association between each category and each brand of the business object. An embodiment provides a method for releasing information of a business object from the perspective of the server. The identification information of the requesting user is extracted after the server receiving the request to release the information of the business object sent by the client in step 1. The releasing range of the business object is determined in accordance with the identification information of the requesting user in step 2. The releasing range of the business object is returned to the client to let the client release the business object by using the received releasing range of the business object.

Another embodiment provides a method for releasing information of a business object. A client sends a request of releasing information of a business object to a server in step 1. A client receives a releasing range of the business object returned from the server in step 2. The releasing range of the business object is determined in accordance with the received information. The releasing range includes at least one category of the business object in a category hierarchy, at least one brand of the business object in a brand hierarchy, and a relationship association between each category and each brand of the business object.

Another embodiment provides a method for releasing information of a business object. A client receives in advance a releasing range of a business object from a server in step 1, and preserves the information of a releasing range locally at the client side. The releasing range includes as least one category of the business object, at lease one brand of the business object, and a relationship between each category and each brand of the business object. The server determines the releasing range upon the receipt of the request to release information of a business object in step 2.

Another embodiment provides a method for releasing information of a business object. A server provides each target user with a releasing range of a business object. The releasing range includes at least one first attribute value in a first hierarchy, at least one second attribute value in a second hierarchy, and a relationship between each first attribute value and each second attribute value. The server receives a request to release information of a business object sent from a client in step 1. The releasing request includes the to be released information of the business object, and additionally selected first and second attribute values of the target user. The server identifies whether the relationship association between the first attribute value and second attribute value falls within the releasing range of the business object in step 2. The server releases the to be released information of business object in accordance with the selected first attribute values and the selected second attribute values if the relationship association between the first attribute value and second attribute value falls within the releasing range of the business object.

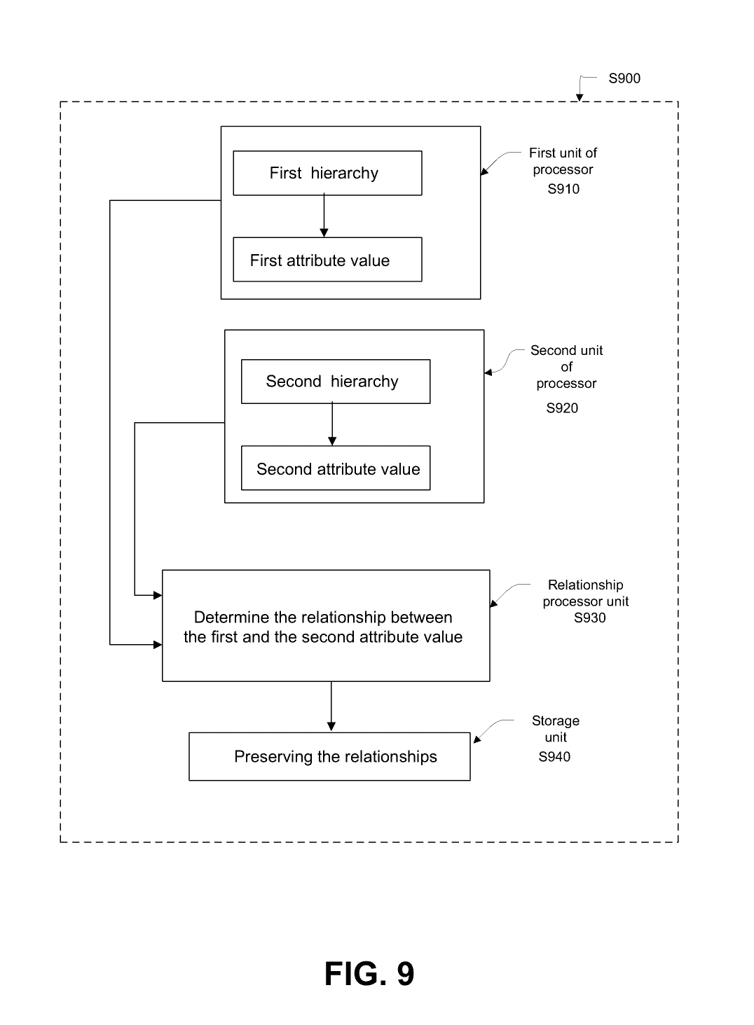

FIG. 9 shows the mechanism of a device for processing information of a business object. The device S900 includes a first unit S910 of a processor to determine at least one first attribute value in the first hierarchy associated with target user, a second unit S920 of the processor to determine at least one second attribute value in the second hierarchy associate with target user. The first hierarchy and the second hierarchy correspond to different category attributes of the business objects. Further, a relationship processor unit S930 determines a relationship between each first attribute value and each second attribute value. A storage unit S940 preserves the relationships and determines a releasing range of the business object in accordance with the relationships.

A device includes a unit of a processor to predetermine a set of first attribute values in a first hierarchy and a set of second attribute values in a second hierarchy, and to generate a table of relationships between the first attribute values and the second attribute values. The relationships are in accordance with the set of first attribute values and the set of second attribute values. Another unit of the processor is included in the device to determine the relationship between each first attribute value and each second attribute value associated with the target user by querying the table.

The device also includes, if a second attribute value does not exist in the table, yet another unit of the processor to determine second qualification information provided by the target user for the second attribute value, and first qualification information for each first attribute value. The first qualification information and the second qualification information include the category information of the business object associated with the target user. A further unit of the processor is used to compare the category information of the business object incorporated in each component of the first qualification information with the category information of the business object incorporated in each component of the second qualification information. Yet another unit of the processor of the device generates the relationships between the first attribute values and the second attribute values, if the similarities between the category information of the business object incorporated in the first qualification information of the first attribute values and the category information of the business object incorporated in the second qualification information of the second attribute values meet the preconditions.

The device also includes another unit of the processor to add relationships between the first attribute values and the second attribute values to the table. A further unit of the processor determines each component of the first qualification information of the first attribute value and each component of the second qualification information of the second attribute value provided by the target user. The first qualification information and the second qualification information include the category information of the business object associated with the target user. Another unit of the processor compares the category information of the business object incorporated in each component of the first qualification information with the category information of the business object incorporated in each component of second qualification information. A further unit of the processor generates the relationship between the first attribute value and the second attribute value, if the similarities between the category information of the business object incorporated in the first qualification information of the first attribute values and the category information of the business object incorporated in the second qualification information of the second attribute values meet the preconditions.

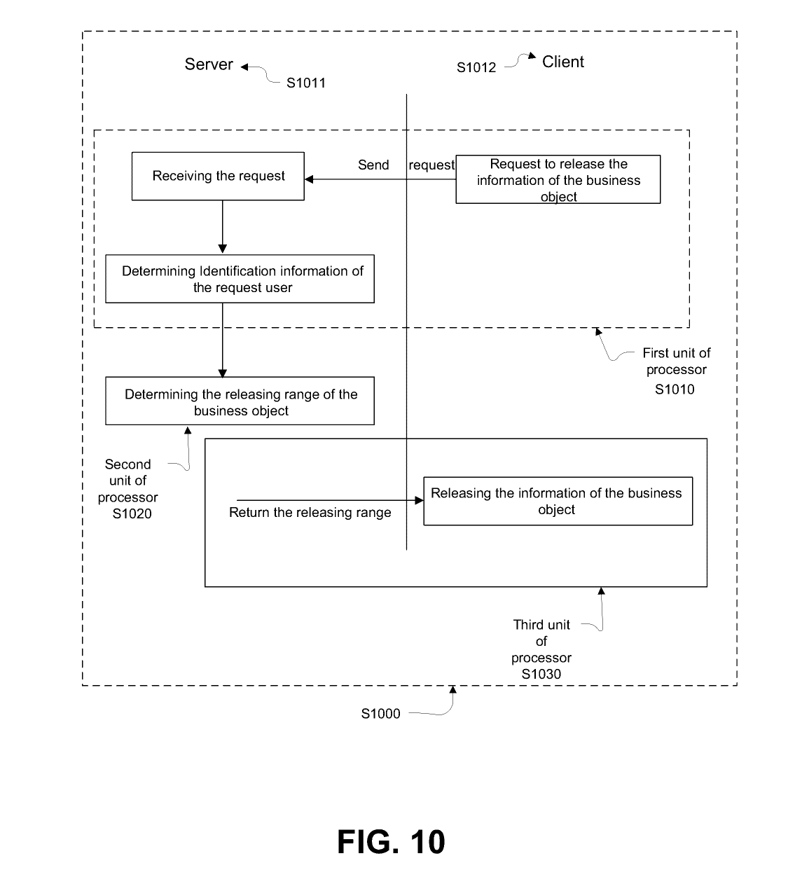

FIG. 10 shows the mechanism of a device for releasing information of a business object. The device is applicable to the server. A server provides each target user with a releasing range of a business object. The releasing range includes at least one first attribute value in a first hierarchy, at least one second attribute value in a second hierarchy, and a relationship association between each first attribute value and each second attribute value. The first attribute values and the second attribute values correspond to different category attributes of the business object. The device includes a first unit S1010 of a processor to extract the identification information of the requesting user upon the receipt of the request sent by a client S1012 to release the information of the business object. The device also includes a second unit S1020 of the processor to determine the releasing range of the business object in accordance with the identification information extracted. The device includes a third unit S1030 of the processor to return a releasing range of the business object to the client to enable the client to release the business object by using the releasing range of the business object received.

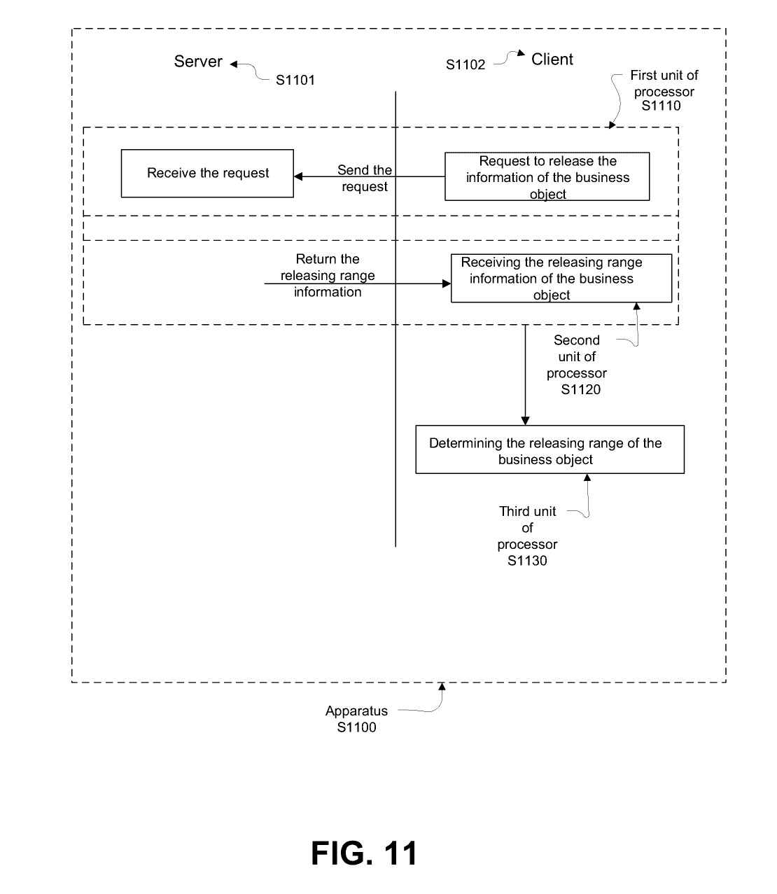

FIG. 11 shows a device S1100 for releasing information of a business object. The device is applicable to a client S1102. The device includes a first unit S1110 of a processor to send a server a request to release information of a business object. The device also includes a second unit S1120 of the processor to receive releasing range information of the business object returned by the server S1101. The device includes a third unit S1130 of the processor to determine the releasing range of the business object in accordance with the received releasing range information. The releasing range includes at least one first attribute value in a first hierarchy, at least one second attribute value in a second hierarchy, and a relationship association between each first attribute value and each second attribute value. The first attribute values and the second attribute values correspond to different category attributes of the business object.

The device of FIG. 11 also provides options for the first attribute value in accordance with the at least one first attribute value in the first hierarchy. The device determines the second attribute value upon the selection of the first attribute value. The second attribute value is related to both the target user in the second hierarchy and the first attribute values of the target user. The device also provides options for the second attribute value in accordance with the second attribute values of the target user.

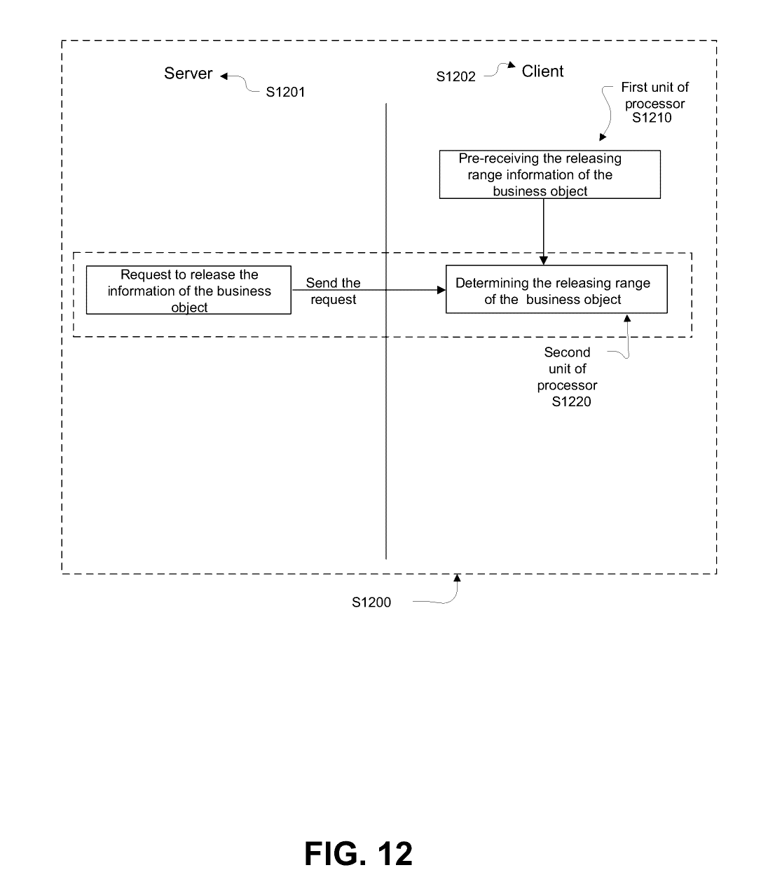

FIG. 12 shows another device S1200 for releasing information of a business object. The device is applicable to a client S1202. The device includes a first unit S1210 of a processor to receive in advance releasing range information of a business object from a server, and to preserve the releasing range information locally at the client side. A releasing range includes at least one first attribute value in a first hierarchy, at least one second attribute value in a second hierarchy, and a relationship association between each first attributive value and each second attribute value. The first attribute values and the second attribute values correspond to different category attributes of the business object. The device includes a second unit S1220 of the processor to determine the releasing range of the business object in accordance with the received releasing range information when receiving a request to release the information of the business object sent from the server S1201.

The device in FIG. 12 also provides options for the first attribute value in accordance with the at least one first attribute value in the first hierarchy. The device determines the second attribute value upon the selection of the first attribute values. The second attribute value is related to both the target user in the second hierarchy and the first attribute values of the target user. The device also provides options for the second attribute value in accordance with the second attribute values of the target user.

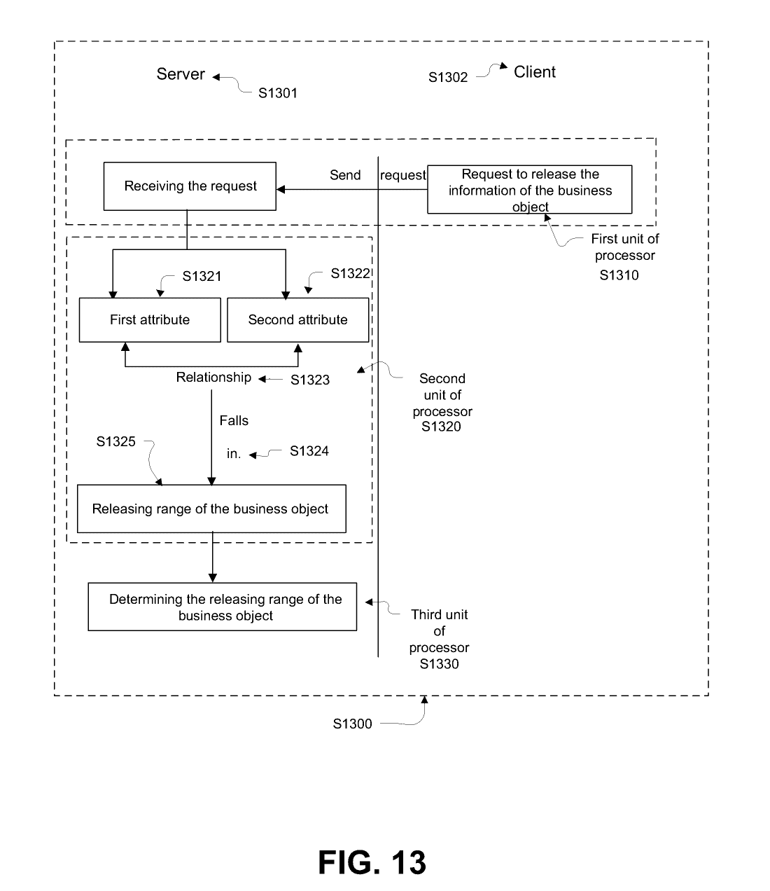

FIG. 13 shows another device S1300 for releasing information of a business object. The device is applicable to a server S1301. The server provides each target user with a releasing range of a business object. The releasing range includes at least one first attribute value in a first hierarchy, at least one second attribute value in a second hierarchy, and a relationship association between the first attribute values and the second attribute values. The device includes a first unit S1310 of a processor to receive a request to release information of the business object sent from the client S1302. The request includes the to be released business object, and additionally selected first and second attribute values of the target user. The device also includes a second unit S1320 of the processor to determine whether the relationship association S1323 between the first attribute value S1321 and the second attribute value S1322 falls within the releasing range of the business object S1325. The device includes a third unit S1330 of the processor to release the to be released business object in accordance with the selected first attribute values and the selected second attribute values if the relationship association between the first attribute values and the second attribute values falls within the releasing range of the business object.

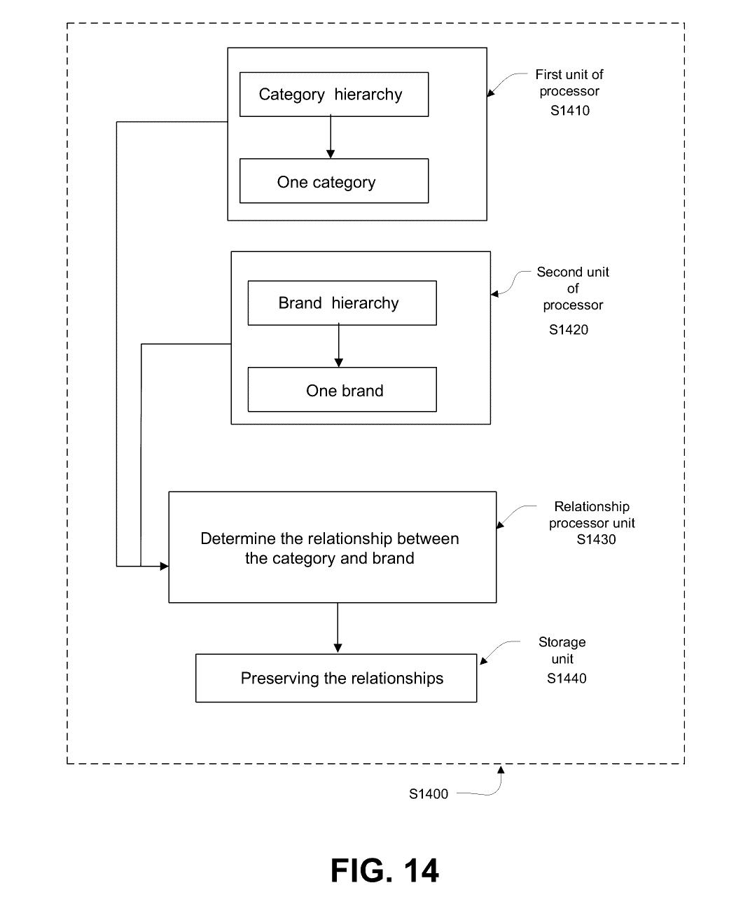

FIG. 14 shows another device S1400 for releasing information of a business object. The device includes a first unit S1410 of a processor to determine at least one category of business object in a category hierarchy associated with a target user, and a second unit S1420 of the processor to determine at least one brand of the business object in a brand hierarchy associated with the target user. The device also includes a third unit S1430 of the processor to determine a relationship between each category and each brand of the target user. The device comprises a storage unit S1440 to preserve the relationships and to determine a releasing range of the business object in accordance with the relationships.

When the category hierarchy includes multistage categories, the device in FIG. 14 also includes another unit of the processor to determine whether the target user is associated with nearly all the sub-categories under the category, and whether each sub-category is associated with the brand of the business object. Yet another unit of the processor merges together the relationship between each subcategory and the corresponding brand of the business object into the relationship between the category and the corresponding brand of the business object and preserves the relationship if the target user is associated with nearly all the sub-categories under the category, and each sub-category is associated with the brand of the business object. The storage unit S1440 preserves the relationship between each sub-category and the corresponding brand of the business object, if the target user is not associated with nearly all the sub-categories under a parent category, or if each sub-category is not associated with the brand of the business object.

According to yet another device for releasing information of a business object, the device is applicable to the server. A server provides each target user with a releasing range of a business object. The releasing range includes at least one category of the business object in a category hierarchy, at least one brand of the business object in a brand hierarchy, and a relationship association between each category and each brand of the business object. The device includes a first unit of a processor to extract the identification information of the requesting user from a request sent from a client to release a business object. The request is to release information of a business object. The device also includes a second unit of the processor to determine the releasing range of the business object in accordance with the identification information of the requesting user. The device includes a third unit of the processor to return the releasing range of the business object to the client to enable the client to release the business object by using the received releasing range of the business object.

According to yet another device for releasing information of a business object, the device is applicable to the client. The device includes a first unit of a processor to send request to release information of the business object to a server. The device also includes a second unit of the processor to receive releasing range information of the business object returned from the server. The device includes a third unit of the processor to determine a releasing range of the business object in accordance with the received releasing range information. The releasing range includes at least one category of the business object in a category hierarchy, at least one brand of the business object in a brand hierarchy, and a relationship association between each category and each brand of the business object.

According to yet another device for releasing information of a business object, the device is applicable to the client. The device includes a first unit of a processor to receive in advance releasing range information of the business object from a server, and to preserve the releasing range information locally at the client side. A releasing range includes at least one category of the business object in a category hierarchy, at least one brand of the business object in a brand hierarchy, and a relationship association between each category and each brand of the business object. The device also includes a second unit of the processor to determine the releasing range of the business object in accordance with the received releasing range information upon receiving the request to release the information of the business object.

According to yet another device for releasing information of a business object, the device is applicable to the server. A server provides each target user with a releasing range of a business object. The releasing range includes at least one category of the business object in a category hierarchy, at least one brand of the business object in a brand hierarchy, and a relationship association between each category and each brand of the business object. The device includes a first unit of a processor to receive by the server a request to release information of a business object sent from a client. The request includes the to be released business object, and the selected categories and the selected brands of the business object. The device also includes a second unit of the processor to determine whether the relationship association between the categories of the business object and the brands of the business object falls within the releasing range of the business object. The device includes a third unit of the processor to release the to be released business object in accordance with the selected categories of the business object and brands of the business object if the relationship association between the categories of the business object and brands of the business object falls within the releasing range of the business object.

In view of the description of the forgoing embodiments, a person skilled in the art can understand that some embodiments can be realized by taking advantage of software plus a universal hardware platform. Based on such understanding, some of the disclosure can be embodied in the format of software products, wherein the computer software can be stored in a storage medium, including but not limited to ROMs/RAMs, disks, CD-ROMs, etc. and several commands to have a computer device (such as personal computers, servers, or network equipment, etc.) execute each embodiments described or part of the methods mentioned.

Although certain embodiments and methods have been disclosed herein, it will be apparent from the foregoing disclosure to those skilled in the art that variations and modifications of such embodiments and methods may be made without departing from the spirit and scope of the disclosure. It is intended that the disclosure be defined by the appended claims and the rules and principles of applicable law.

What is claimed is:

1. An information processing method, comprising:
determining at least one first attribute value in a first hierarchy associated with a target user;
determining at least one second attribute value in a second hierarchy associated with the target user, wherein the first hierarchy and the second hierarchy correspond to different category attributes of a business object;
determining relationships between the first attribute values of the target user and the second attribute values of the target user; and
preserving the relationships between the first and second attribute values to ascertain a releasing range of the business object in accordance with determined relationships.

2. The method of claim 1, further comprising:
predetermining a set of first attribute values in the first hierarchy;
predetermining a set of second attribute values in the second hierarchy, wherein the set of first attribute values is associated to the set of second attribute values;
creating a table showing the relationships between the set of first attribute values and the set of second attribute values; and
determining the relationship between each first attribute value and each second attribute value by querying the table of relationships.

3. The method of claim 2, further comprising:
using first qualification information provided by the target user to determine each first attribute value;
using, when a second attribute value is nonexistent in the table of relationships, second qualification information provided by the target user to determine the second attribute value for the nonexistent second attribute value in the table, wherein both the first and second qualification information include category information of the business object related to the target user;
comparing category information of components of the business object of the first qualification information to category information of components of the business object in the second qualification information; and
generating relationships between the first attribute value and the second attribute value; and
creating a set of similarities between category information of the business object in the first qualification information of the first attribute value and category information of the business object in the second qualification information of the second attribute value when certain sets of preconditions are met.

4. The method of claim 3, further comprising:
adding a set of relationships between the first attribute value and the second attribute value to the table showing the relationships, if the set is nonexistent in the table of relationships.

5. The method of claim 3, further comprising,
determining each component of the first qualification information provided by the target user for the first attribute values;
determining each component of the second qualification information provided by the target user for the second attribute values, wherein the first qualification information and the second qualification information include the category information of the business object related to the target user;
comparing category information of business objects incorporated in each component of the first qualification information to category information of business objects incorporated in each component of the second qualification information; and
generating relationships between the first attribute value and the second attribute value by determining similarities between the category information of the business object incorporated in the first qualification information of the first attribute value and the category information of the business object incorporated in the second qualification information of the second attribute value upon meeting preconditions.

6. An information processing method, comprising:
determining at least one category of a business object in a category hierarchy associated with the target user, and at least one brand of the business object in a brand hierarchy associated with the target user;
determining a relationship between each category and each brand of the target user; and
preserving the relationship to ascertain a releasing range of the business object in accordance with the relationship.

7. The method of claim 6, further comprising:
determining whether the target user is associated with a plurality of the sub-categories under the category, and whether each sub-category is associated with a brand of the business object; and
merging together each subcategory and the corresponding brand of the business object into a relationship association between the category and the corresponding brand of the business object; and
preserving the relationship association when the target user is associated with a plurality of the sub-categories under the category and each sub-category is associated with the brand of the business object.

8. The method of claim 7, further comprising:
preserving the relationship association between each sub-category and the corresponding brand of the business object if the target user is not associated with nearly all the sub-categories under the category or when each sub-category is not associated with the brand of the business object.

9. An information processing method, comprising:
providing each target user with a releasing range of a business object, wherein the releasing range includes at least one category of the business object in the category hierarchy, at least one brand of the business object in the brand hierarchy, and a relationship association between the category of the business object and each brand of the business object;
extracting identification information of a requesting user if a server receives a request to release information of the business object via the request sent from a client side;
determining the releasing range of the business object in accordance with the identification information extracted; and
returning the releasing range of the business object to the client in response to the request in order to enable the client to release the business object by using the releasing range returned.

10. An information processing method, comprising:
sending a request to release information of a business object to a server;
receiving releasing range information of the business object returned from the server; and
determining a releasing range of the business object by using the received releasing range information, wherein the releasing range comprises at least one category of the business object in a category hierarchy, at least one brand of the business object in a brand hierarchy, and a relationship association between the category of the business object and the brand of the business object.

11. An information processing apparatus, comprising:
a first unit of a processor to determine at least one first attribute value in a first hierarchy associated with a target user, determine at least one second attribute value in a second hierarchy associated with the target user, wherein the first hierarchy and the second hierarchy correspond to different category attributes of a business object;
a second unit of the processor to determine relationships between the first attribute values of the target user and the second attribute values of the target user; and
a storage unit to store the relationships between the first and second attribute values to ascertain a releasing range of the business object in accordance with the determined relationships.

12. The apparatus of claim 11, further comprising:
a third unit of the processor to predetermine a set of first attribute values in the first hierarchy and to predetermine a set of second attribute values in the second hierarchy, wherein the set of first attribute values is associated to the set of second attribute values;
a fourth unit of the processor to create a table to show the relationships between the first attribute values and the second attribute values; and
a fifth unit of the processor to determine the relationship between each first attribute value and each second attribute value by querying the table of relationships.

13. The apparatus of claim 12, further comprising:
a sixth unit of the processor to determine, using first qualification information provided by the target user, each first attribute value;
a seventh unit of the processor to process, when a second attribute value is nonexistent in the table of relationships, second qualification information provided by the target user to determine the second attribute value for the nonexistent second attribute value in the table, wherein both the first and second qualification information include category information of the business object related to the target user;
a eighth unit of the processor to compare category information of components of the business object of the first qualification information to category information of components of the business object in the second qualification information; and
a ninth unit of the processor to generate relationships between the first attribute value and the second attribute value, and to create a set of similarities between category information of the business object in the first qualification information of the first attribute value and category information of the business object in the second qualification information of the second attribute value when certain sets of preconditions are met.

14. The apparatus of claim 13, further comprising:
a tenth unit of the processor to add the relationships between the first attribute values and the second attribute values to the table of relationships.

15. The apparatus of claim 13, further comprising:
an eleventh unit of the processor to determine each component of the first qualification information provided by the target user for the first attribute values, to determine each component of the second qualification information provided by the target user for the second attribute values, wherein the first and second qualification information include category information of the business object associated with the target user;
a twelfth unit of the processor to compare category information of components of the business object of the first qualification information to category information of components of the business object in the second qualification information; and
a thirteenth unit of the processor to generate the relationships between the first attribute value and the second attribute value by determining similarities between category information of the business object incorporated in the first qualification information of the first attribute value and category information of the business object incorporated in the second qualification information of the second attribute value upon meeting preconditions.

16. An information processing apparatus, comprising:
a first unit of a processor to send a request to release information of a business object from a client to a server;
a second unit of the processor to receive releasing range information of the business object forwarded back from the server in response to the request; and
a third unit of the processor to determine a releasing range of the business object by using the received releasing range information, wherein the releasing range includes at least one first attribute value in a first hierarchy, at least one second attribute value in a second hierarchy and a relationship association between the first and second attribute values, which correspond to different category attributes of the business object.

17. The apparatus of claim 16, further comprising:
a fourth unit of the processor to provide a first set of options for selecting the first attribute value with at least one first attribute of the target user;
a fifth unit of the processor to determine a second attribute value upon the selection of the first attribute value, wherein the second attribute value is related to both the target user in the second hierarchy and the first attribute value of the target user; and
a sixth unit of the processor to provide a second set of options for selecting the second attribute value with at least one second attribute of the target user.

18. An information processing apparatus, comprising:
a first unit of the processor to receive, in advance, releasing range information of a business object sent from a server;
a second unit of the processor to preserve the releasing range information locally at a client side, wherein a releasing range includes at least one first attribute value in a first hierarchy, at least one second attribute value in a second hierarchy, and a relationship association between the first and second attributive values which corresponds to different category attributes of the business object; and
a third unit of the processor to determine, by using the advanced received releasing range information, the releasing range of the business object in an immediate manner upon receiving the request to release the business object at the client side.

19. The apparatus of claim 18, further comprising:
a fourth unit of the processor to provide a first set of options for selecting the first attribute value with at least one first attribute of the target user;
a fifth unit of the processor to determine a second attribute value upon the selection of the first attribute value, wherein the second attribute value is related to both the target user in the second hierarchy and the first attribute value of the target user; and
a sixth unit of the processor to provide a second set of options for selecting the second attribute value with at least one second attribute of the target user.

20. An information releasing apparatus, comprising:
a server operable to provide a target user with a releasing range of a business object, wherein the releasing range includes at least one category of the business object in a category hierarchy, at least one brand of the business object in a brand hierarchy, and a relationship association between each category of the business object and each brand of the business object;
a first unit of a processor for the server to receive a request to release information of the business object sent from a client, wherein the request includes the business object to be released, and selected categories and brands of the business object to be released;
a second unit of the processor to determine whether there exists a relationship association between the categories of the business object and brands of the business object in a releasing range of the business object; and
a third unit of the processor to proceed to release the business object of the selected categories and brands if a relationship association between the category of the business object and the brands of the business object falls within the releasing range of the business object.
